(19) United States
(12) Patent Application Publication
(10) Pub. No.: US 2015/0049473 A1
(43) Pub. Date: Feb. 19, 2015

(54) LED TUBE HAVING LONG INTERNAL CREEPAGE DISTANCES

(71) Applicant: LUXUL TECHNOLOGY INCORPORATION, New Taipei City (TW)

(72) Inventors: Cheng-Hung Pan, New Taipei City (TW); Yung-Ta Hung, New Taipei City (TW); Cheng-Hsien Chen, New Taipei City (TW)

(73) Assignee: LUXUL TECHNOLOGY INCORPORATION, New Taipei City (TW)

(21) Appl. No.: 14/160,543

(22) Filed: Jan. 21, 2014

(30) Foreign Application Priority Data
Aug. 15, 2013 (TW) 102129260

(51) Int. Cl. F21K 99/00; F21V 29/00

(52) U.S. Cl. CPC F21K 9/175; F21V 29/2206
USPC 362/218

(57) ABSTRACT

An LED tube has a tube body, an LED light board and two caps. The tube body has a translucent tube shell and a heat dissipating seat. The translucent tube shell has two openings, a gap, two side walls separated by the gap, two first slide tracks and two second slide tracks. The heat dissipating seat is mounted in the gap and has two opposite sides respectively mounted in the two first slide tracks. The LED board abuts the heat dissipating seat and has two opposite sides respectively mounted in the two second slide tracks. The sides of the heat dissipating seat and the sides of the LED light board are separated by the first and the second slide tracks to extend creepage distances between the heat dissipating seat and the LED light board, and further avoid a short circuit between the heat dissipating seat and the LED light board.

### BACKGROUND OF THE INVENTION

1. Field of the Invention

The present invention relates to a light tube and more particularly to an LED tube having long internal creepage distances.

2. Description of Related Art

LEDs have features of small volume, high luminous efficiency and long service life. Thus, LED tubes using LEDs as light sources have become more and more common.

With reference to FIG. 15, a conventional LED tube has a heat dissipating seat 60, an LED light board 70, a translucent tube shell 80 and two caps 90.

The heat dissipating seat 60 is semi-cylindrical and has a rectangular flat surface, a convex surface, multiple fins 61 and two slide tracks 62. The rectangular flat surface has two opposite long sides and two opposite short sides. The multiple fins 61 are formed concave on the convex surface, and the two slide tracks 62 are respectively formed on the two long sides of the flat surface.

The LED light board 70 is rectangular and has two opposite long sides, two opposite short sides vertically connected to the two long sides, four electrical connecting parts 71 and multiple LED units 72. The two long sides of the LED light board 70 are slidably mounted in the two slide tracks 62 respectively. Thus, the LED light board 70 is mounted on the flat surface of the heat dissipating seat 60, and the two short sides of the LED light board 70 are respectively in alignment with the two short sides of the flat surface. Each two of the four electrical connecting parts 71 are mounted on the LED light board 70 and near a corresponding short side of the LED light board 70. The multiple LED units 72 are mounted at intervals on the LED light board 70 in a longitudinal direction of the LED light board 70.

The translucent tube shell 80 is semi-cylindrical and is connected to the heat dissipating seat 60 to form a tube body, wherein the translucent tube shell 80 faces the multiple LED units 72 of the LED light board 70.

Each cap 90 is sleeved on a corresponding end of the tube body and has two electrode pins 91 respectively and electrically connected to two of the electrical connecting parts 71 that are adjacent to the corresponding end.

When the LED tube is mounted in a lamp holder and is switched on, the LED light board 70 obtains power through the four electrode pins 91 of the two caps 90 and glows by the multiple LED units 72. Heat produced by the functioning LED light board 70 is conducted to the heat dissipating seat 60 and further dissipated by the multiple fins 61.

With reference to FIG. 16, the two electrical connecting parts 71 on each short side of the LED light board 70 are near the two slide tracks 62 of the heat dissipating seat 60, wherein a material of the heat dissipating seat 60 is metal and is electrically conductive, that is, creepage distances between the connecting parts 71 and the radiating bar 60 are very short. When the LED tube is switched on, the connecting parts 71 obtain a high voltage power, and a surface of the LED light board 70 adjacent to the connecting parts 71 may be electrically polarized by high voltage and become electrically conductive. Thus, the high voltage power obtained by the connecting parts 71 may be conducted to the heat dissipating seat 60 through the electrically polarized surface of the LED light board 70 and causes short-circuit that damages the LED light board 70.

Furthermore, each cap 90 is sleeved only on a corresponding end of the tube body consisting of the heat dissipating seat 60 and the translucent tube shell 80, that is, a connection between each cap 90 and the tube body is not stable. When an unexpected force is applied on the LED tube, the caps 90 are to rotate easily and cause a deviation of the illumination angle of the LED tube.

### SUMMARY OF THE INVENTION

The main objective of the invention is to provide an LED tube which has long internal creepage distances.

The LED tube comprises a tube body, an LED light board and two caps. The tube body has a translucent tube shell and a heat dissipating seat. The translucent tube shell has two openings, a gap, two side walls, two first slide tracks and two second slide tracks. The gap is formed through the translucent tube shell in a longitudinal direction of the translucent tube shell. The two side walls are separated by the gap. The two first slide tracks are respectively formed on the two side walls and parallel to the gap, and the two second slide tracks are respectively formed on the two side walls and parallel to the gap, wherein the two second slide tracks are respectively located above the two first slide tracks. The heat dissipating seat has two opposite sides respectively mounted in the two first slide tracks. The LED light board has two opposite sides, two opposite ends, a back surface and a luminous surface opposite to the back surface, wherein the two sides of the LED light board are respectively mounted in the two second slide tracks. The two ends of the LED light board are connected to the two sides of the LED light board. The luminous surface faces toward the translucent tube shell, and the back surface abuts the heat dissipating seat. The two caps are respectively mounted on and covering the two openings of the translucent tube shell, wherein each cap has two electrode pins electrically connected to the LED light board.

The sides of the heat dissipating seat and the sides of the LED light board are respectively mounted in the first and the second slide tracks of the electrically insulating translucent tube shell, that is, the sides of the heat dissipating seat and the sides of the LED light board are separated by the first and the second slide tracks, and only the back surface of the LED light board abuts the heat dissipating seat to radiate the LED light board when the LED tube is switched on. The luminous surface is opposite to the back surface, thus, the luminous surface and the back surface are separated by the LED light board. The advantage of the LED tube in accordance with the present invention is that electronic components are mostly mounted on a luminous surface of an LED light board, wherein the luminous surface of the LED tube in accordance with the present invention does not contact to the metal heat dissipating seat. Therefore, a creepage distance between the luminous surface of the LED light board and the heat dissipating seat is extended.

Another objective of the invention is to provide an LED tube having caps firmly mounted on the LED tube.

Wherein the heat dissipating seat further comprises a top surface and a bottom surface. The bottom surface has multiple fins and two semi-annular grooves. The multiple fins are formed from the bottom surface and extend toward the gap of the translucent tube shell. The two semi-annular grooves are respectively formed on two adjacent fins of the multiple fins and face each other. Each cap comprises a screw having a screw head and a screw rod. The screw rod is mounted through the cap and between the two semi-annular grooves of the heat dissipating seat, and the screw head abuts the cap to screw the cap on a corresponding one of the two openings of the translucent tube shell.

In conclusion, the two caps are firmly mounted on and covering the openings of the translucent tube shell via the two semi-annular grooves of the radiating bar and the screws of the two caps.

### BRIEF DESCRIPTION OF THE DRAWINGS

FIG. 1 is a partially exploded view of a first embodiment of an LED tube in accordance with the present invention;

FIG. 2 is an exploded view of the LED tube in FIG. 1;

FIG. 3 is a side view in cross section of the LED tube in FIG. 1;

FIG. 4 is a partially exploded view of a second embodiment of an LED tube in accordance with the present invention;

FIG. 5 is an exploded view of the LED tube in FIG. 4;

FIG. 6 is a top view in cross section of the LED tube in FIG. 4;

FIG. 7 is a front view in cross section of the LED tube in FIG. 4, shown without a cap;

FIG. 8 is a partially exploded view of a third embodiment of an LED tube in accordance with the present invention;

FIG. 9 is an exploded view of the LED tube in FIG. 8;

FIG. 10 is a side view in cross section of the LED tube in FIG. 8;

FIG. 11 is a partially exploded view of a fourth embodiment of an LED tube in accordance with the present invention;

FIG. 12 is an exploded view of the LED tube in FIG. 11;

FIG. 13 is a top view in cross section of the LED tube in FIG. 11;

FIG. 14 is a side view in cross section of the LED tube in FIG. 11;

FIG. 15 is a partially exploded view of a conventional LED tube; and

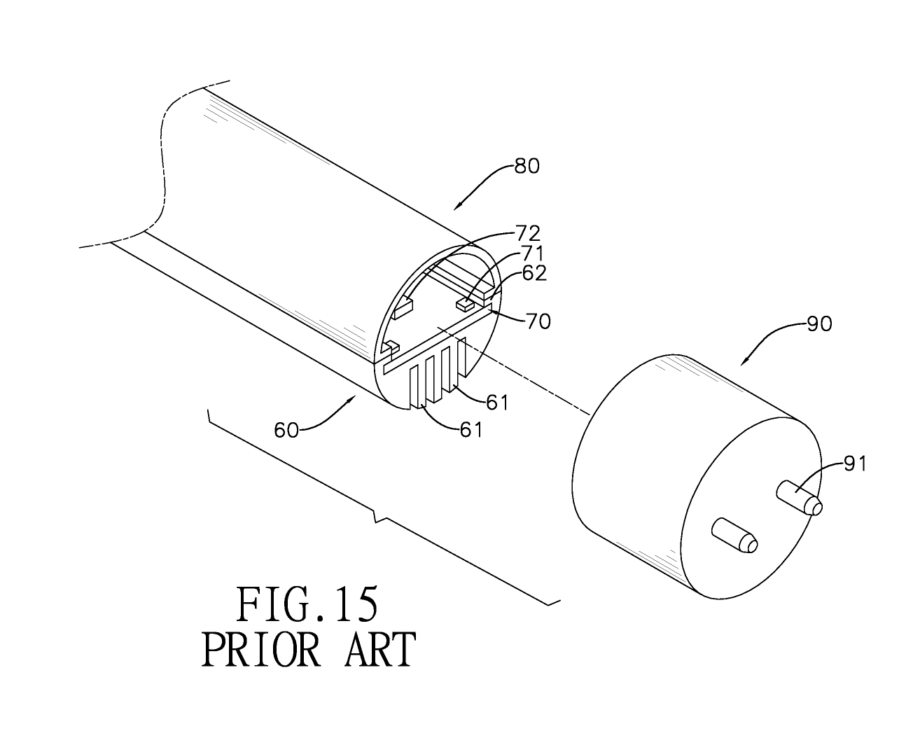

FIG. 16 is a top view in cross section of the conventional LED tube in FIG. 15.

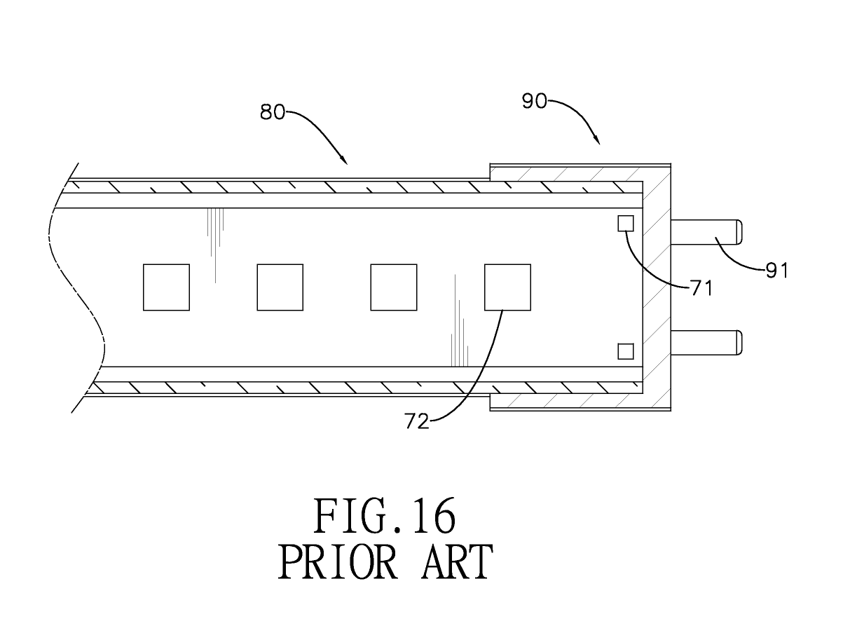

### DETAILED DESCRIPTION OF THE PREFERRED EMBODIMENTS

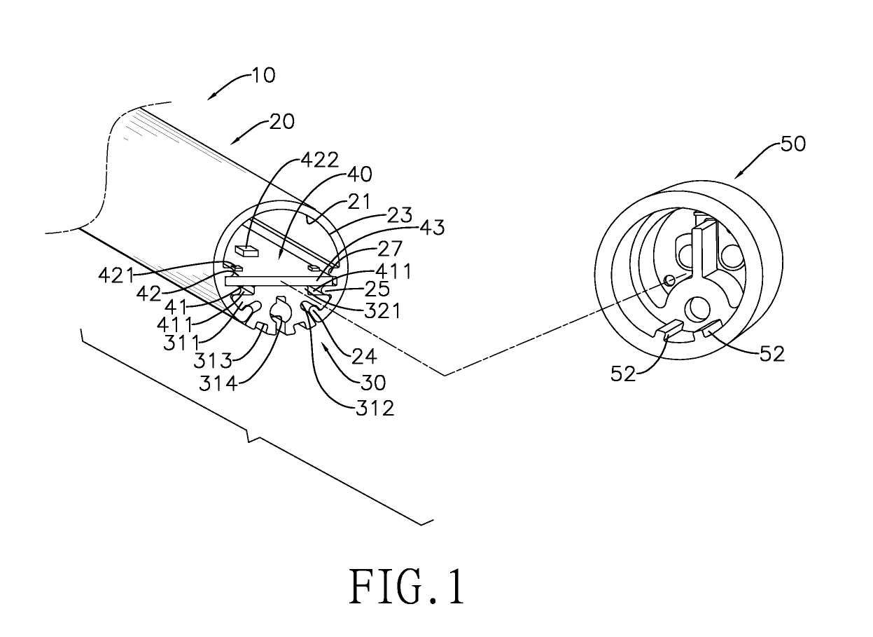

With reference to FIGS. 1 to 3, a first embodiment of an LED tube in accordance with the present invention comprises a tube body 10, an LED light board 40 and two caps 50.

The tube body 10 comprises a translucent tube shell 20 and a heat dissipating seat 30.

The translucent tube shell 20 is electrically insulating and has two openings 21, a gap 22, two side walls 23, two first ribs 24, two second ribs 25, two first slide tracks 26, two third ribs 27 and two second slide tracks 28. The gap 22 is formed through the translucent tube shell 20 in a longitudinal direction of the translucent tube shell 20. The two side walls 23 are separated by the gap 22. The two first ribs 24 are respectively formed on the two side walls 23 and adjacent to the gap 22. The two second ribs 25 are respectively formed on the two side walls 23, and are respectively located above the two first ribs 24. Each first slide track 26 is formed between a corresponding one of the side walls 23, the first rib 24 formed on said corresponding side wall 23, and the second rib 25 formed on said corresponding side wall 23. The two third ribs 27 are respectively formed on the two side walls 23 and are respectively located above the two second ribs 25. Each second slide track 28 is formed between a corresponding side wall 23, the second rib 25 formed on said corresponding side wall 23, and the third rib 27 formed on said corresponding side wall 23.

The heat dissipating seat 30 is mounted in the gap 22 of the translucent tube shell 20, and the heat dissipating seat 30 is made of metal, which is highly conductive. The heat dissipating seat 30 has two opposite sides along a longitudinal direction of the heat dissipating seat 30, a bottom surface 31 and a top surface 32 opposite to the bottom surface 31. The bottom surface 31 faces toward the gap 22 and has two slide bars 311, two fins 312, two fork parts 313 and two semi-annular grooves 314. The two slide bars 311 respectively extend from the two opposite sides of the heat dissipating seat 30, wherein the two slide bars 311 are slidably mounted in the two first slide tracks 26 of the translucent tube shell 20 respectively. Each fin 312 extends downward from the bottom surface 31. The two fork parts 313 are respectively formed on the two fins 312 to increase radiating areas of the two fins 312. The two semi-annular grooves 314 are respectively formed on the two fins 312 and face each other. The top surface 32 has an abutting part 321 extending upward from the top surface 32.

The LED light board 40 is slidably mounted in the tube body 10 and has two opposite sides slidably mounted in the two second slide tracks 28 respectively, two opposite ends 43 connected to the two sides of the LED light board 40, a back surface 41, and a luminous surface 42 opposite to the back surface 41. The two ends 43 are respectively near the two openings 21 of the translucent tube shell 20. The back surface 41 abuts the abutting part 321 of the heat dissipating seat 30. A length of the LED light board 40 in a width direction of the LED light board 40 is longer than a length of the abutting part 321 in a width direction of the abutting part 321. The two opposite sides of the LED light board 40 respectively extend out of the abutting part 321, and thus, an extending space 411 is respectively formed between the back surface 41, the abutting part 321 and each of the two slide bars 311. The luminous surface 42 has four electrical connecting parts 421 and multiple LED units 422. Each two electrical connecting parts 421 are mounted near a corresponding one of the two ends 43 of the luminous surface 42. The multiple LED units 422 are mounted at intervals on the luminous surface 42 in a longitudinal direction of the LED light board 40.

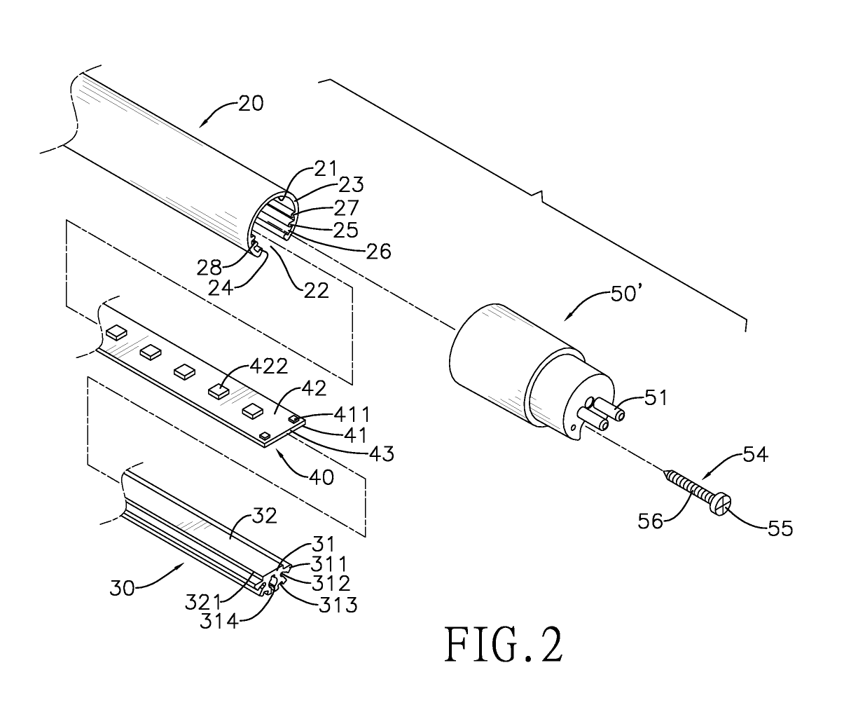

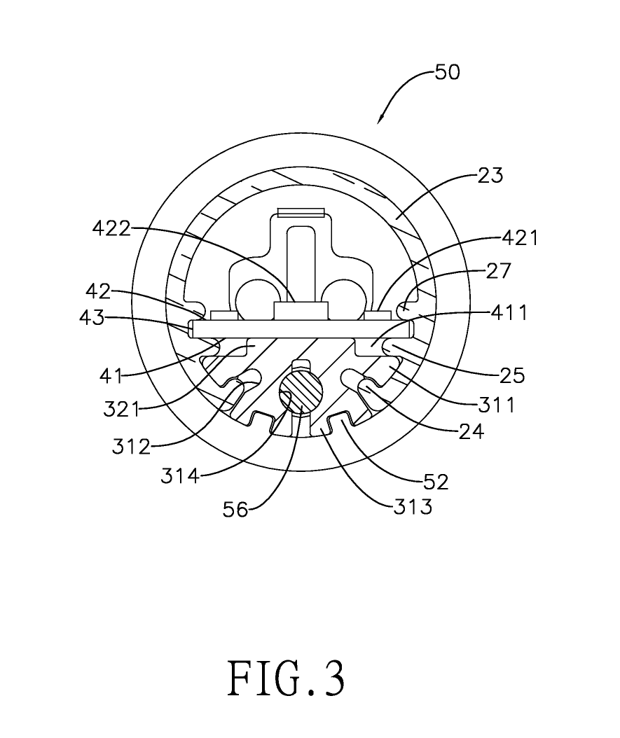

The caps 50 are respectively sleeved on the two openings 21 of the translucent tube shell 20. Each cap 50 has an inner wall, two electrode pins 51 and two fin fixing parts 52. The two electrode pins 51 are mounted through the cap 50 and are electrically connected to two corresponding ones of the electrical connecting parts 421 respectively. The two fin fixing parts 52 are formed on the inner wall of the cap 50 and respectively correspond in position to the two fork parts 313 of the two fins 312. Furthermore, with reference to FIGS. 2 and 3, each cap 50 further has a screw 54, wherein the screw 54 has a screw head 55 and a screw rod 56 connected to the screw head 55. The screw rod 56 is mounted through the cap 50 and between the two semi-annular grooves 314 of the heat dissipating seat 30, and the screw head 55 abuts the cap 50 to screw the cap 50 on a corresponding one of the two openings 21 of the translucent tube shell 20.

In conclusion, when the first embodiment of the LED tube in accordance with the present is mounted in a holder and switched on, the LED light board 40 obtains power from the electrode pins 51 of the caps 50 via the four electrical connecting parts 421 and starts to glow by the multiple LED units 422. The two opposite sides of the heat dissipating seat 30 and the two opposite sides of the LED light board 40 are respectively mounted in the two first slide tracks 26 and the two second slide tracks 28 of the electrically insulating translucent tube shell 20, that is, the LED light board 40 is not mounted on the metal heat dissipating seat 30. Only the back surface 41 of the LED light board 40 abuts the abutting part 321 of the heat dissipating seat 30, and the luminous surface 42 is distal from the heat dissipating seat 30. Therefore, internal creepage distances of the first embodiment of the LED tube in accordance with the present invention is extended to avoid a short-circuit between the heat dissipating seat 30 and the LED light board 40 due to short creepage distances.

Furthermore, the two extending spaces 411 retain spaces for an expanding volume of the heat dissipating seat 30 due to thermal expansion when the heat dissipating seat 30 absorbs heat from the LED light board 40, thus, the LED light board 40 would not be pressed and damaged by thermal stress from the thermal expansion of the heat dissipating seat 30.

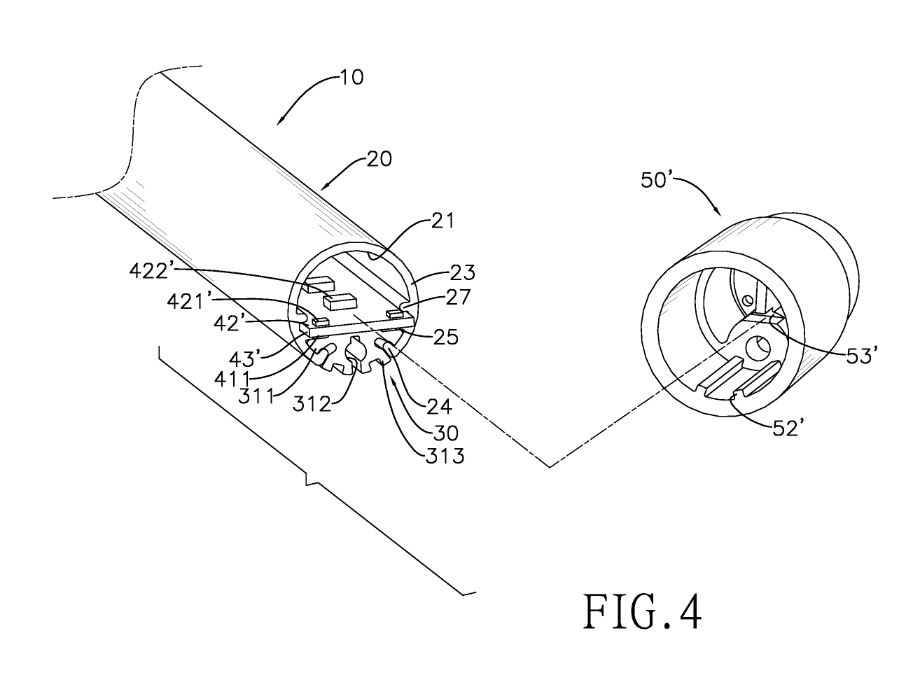

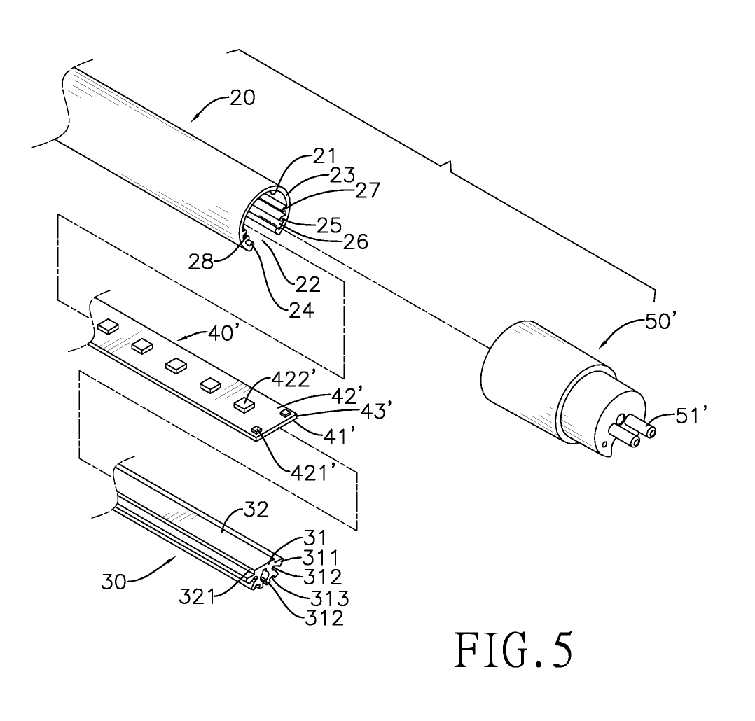

With reference to FIGS. 4 to 7, a second embodiment of an LED tube in accordance with the present invention comprises a tube body 10, an LED light board 40′ and two caps 50′, wherein a structure of the tube body 10 of the second embodiment is similar to that of the first embodiment. Therefore, description of the structure of the tube body 10 will not be repeated in the following paragraphs.

The LED light board 40′ is mounted in the tube body 10 and has two opposite sides respectively mounted in the two second slide tracks 28, two opposite ends 43′ connected to the two sides of the LED light board 40′, a back surface 41′ and a luminous surface 42′ opposite to the back surface 41′. The two ends 43′ are respectively near the two openings 21 of the translucent tube shell 20. The back surface 41′ abuts the abutting part 321 of the heat dissipating seat 30. A length of the back surface 41′ in a width direction of the back surface 41′ is longer than a length of the abutting part 321 in a width direction of the abutting part 321, and thus, an extending space 411′ is respectively formed between the back surface 41′ and each of the two slide bars 311. The luminous surface 42′ has four electrical connecting parts 421′ and multiple LED units 422′. The multiple LED units 422′ are mounted at intervals on the luminous surface 42′ in a longitudinal direction of the LED light board 40′. In this embodiment, a length of the LED light board 40′ in a longitudinal direction of the LED light board 40′ is also longer than a length of the abutting part 321 in a longitudinal direction of the abutting part 321. The two opposite ends 43′ of the LED light board 40′, which are respectively near the two openings 21 of the translucent tube shell 20, respectively extend out of the heat dissipating seat 30, wherein each two electrical connecting parts 421′ are mounted near a corresponding one of the two ends 43′ on the luminous surface 42′ of the LED light board 40′.

The caps 50′ are respectively sleeved on the two openings 21 of the translucent tube shell 20. Each cap 50′ has an inner wall, two electrode pins 51′ and two fin fixing parts 52′. The two electrode pins 51′ are mounted through the cap 50′ and are electrically connected to two corresponding ones of the electrical connecting parts 421′ respectively. The two fin fixing parts 52′ are formed on the inner wall of the cap 50′ and respectively correspond in position to the two fork parts 313 of the two fins 312. In this embodiment, each cap 50′ further has a board fixing groove 53′, wherein each end 43′ of the LED light board 40′ is mounted in a corresponding one of the two board fixing grooves 53′ of the two caps 50′.

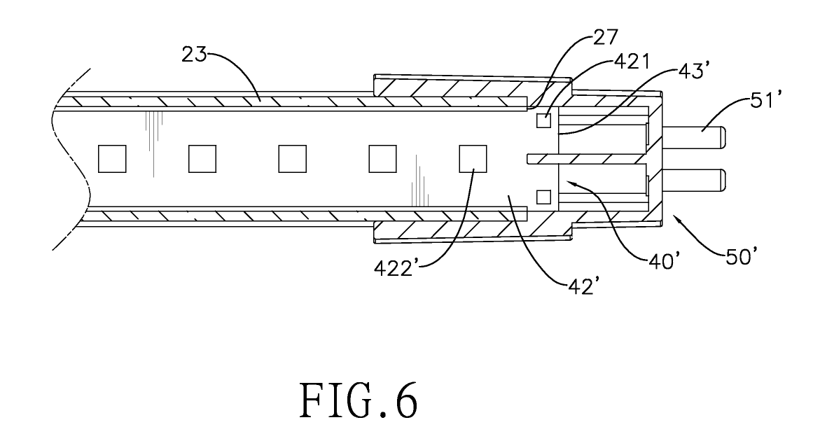

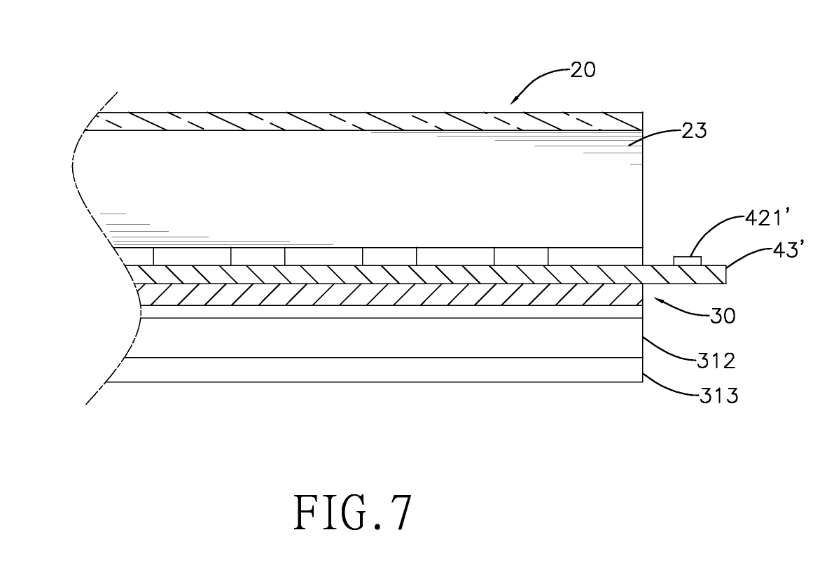

With reference to FIGS. 6 and 7, the two opposite ends 43′ of the LED light board 40′ extends out of the heat dissipating seat 30, thus, distances between the electrical connecting parts 421′ mounted on the ends 43′ and the heat dissipating seat 30 are further extended. Therefore, the internal creepage distances of the second embodiment of the LED tube in accordance with the present invention are further extended.

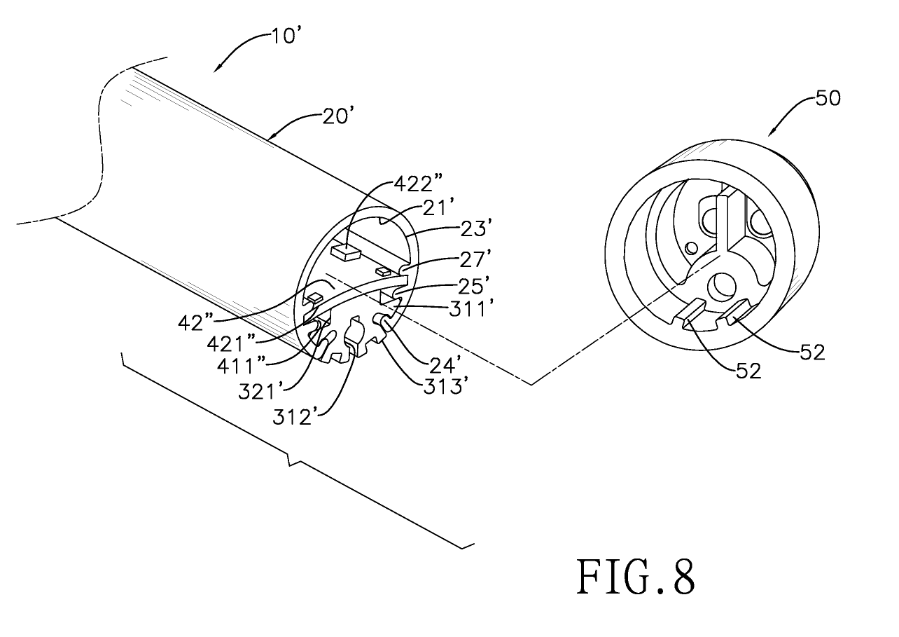

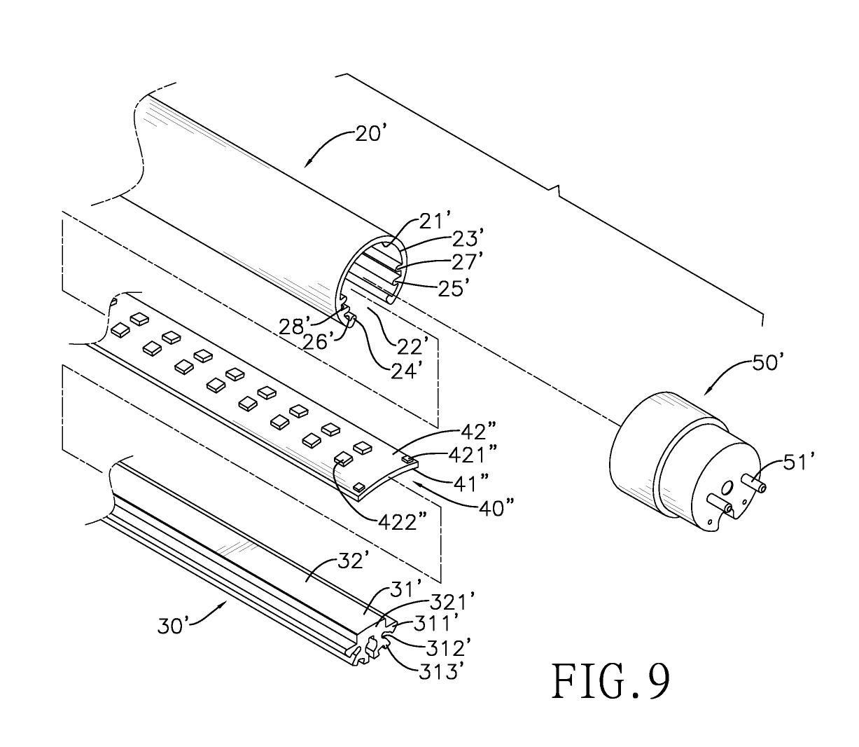

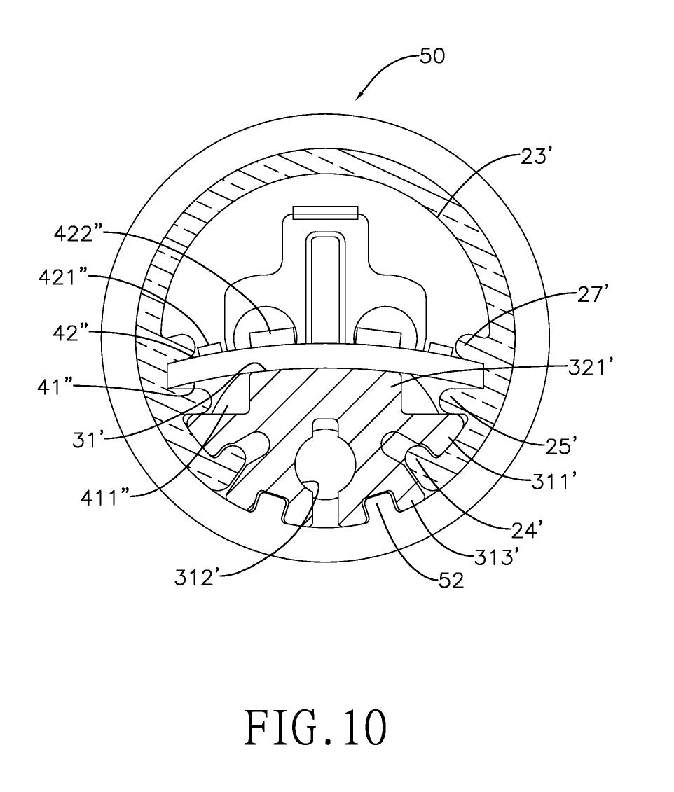

With reference to FIGS. 8 to 10, a third embodiment of an LED tube in accordance with the present invention comprises a tube body 10′, an LED light board 40″ and two caps 50, wherein a structure of the two caps 50 of the third embodiment is similar to that of the first embodiment. Therefore, description of the structure of the two caps 50 will not be repeated in the following paragraphs.

The tube body 10′ comprises a translucent tube shell 20′ and a heat dissipating seat 30′.

The translucent tube shell 20′ is electrically insulating and has two openings 21′, a gap 22′, two side walls 23′, two first ribs 24′, two second ribs 25′, two first slide tracks 26′, two third ribs 27′ and two second slide tracks 28′. The gap 22′ is formed through the translucent tube shell 20′ in a longitudinal direction of the translucent tube shell 20′. The two side walls 23′ are separated by the gap 22′. The two first ribs 24′ are respectively formed on the two side walls 23′ and adjacent to the gap 22′. The two second ribs 25′ are respectively formed on the two side walls 23′, and respectively located above the two first ribs 24′. Each first slide track 26′ is formed between a corresponding one of the two side walls 23′, the first rib 24′ formed on said corresponding side wall 23′, and the second rib 25′ formed on said corresponding side wall 23′. The two third ribs 27′ are respectively formed on the two side walls 23′ and respectively located above the two second ribs 25′. Each second slide track 28′ is formed between a corresponding one of the side walls 23′, the second rib 25′ formed on said corresponding side wall 23′, and the third rib 27′ formed on said corresponding side wall 23′.

The heat dissipating seat 30′ is mounted in the gap 22′ of the translucent tube shell 20′ and a material of the heat dissipating seat 30′ is metal. The heat dissipating seat 30′ has two opposite sides along a longitudinal direction of the heat dissipating seat 30′, a bottom surface 31′ and a top surface 32′ opposite to the bottom surface 31′. The bottom surface 31′ faces toward the gap 22′ and has two slide bars 311′, two fins 312′, two fork parts 313′ and two semi-annular grooves 314′. The two slide bars 311′ respectively extend from the two opposite sides of the heat dissipating seat 30′, wherein the two slide bars 311′ are slidably mounted in the two first slide tracks 26′ of the translucent tube shell 20′ respectively. Each fin 312′ extends downward from the bottom surface 31′. The two fork parts 313 are respectively formed on the two fins 312′ to increase radiating areas of the two fins 312′. The two semi-annular grooves 314′ are respectively formed in the two fins 312′ and face each other. The top surface 32′ has an abutting part 321′ extending upward from the top surface 32′. In this embodiment, the top surface 32′ is convex toward the translucent tube shell 20′. A radian of the top surface 32′ is between π/2 and 5π/6.

The LED light board 40″ is slidably mounted in the tube body 10′ and has two opposite sides slidably mounted in the two second slide tracks 28′ respectively, two opposite ends 43″ connected to the two sides of the LED light board 40″, a back surface 41″ and a luminous surface 42″ opposite to the back surface 41″. The back surface 41″ abuts the abutting part 321′ of the heat dissipating seat 30′. A length of the LED light board 40″ in a width direction of the LED light board 40″ is longer than a length of the abutting part 321′ in a width direction of the abutting part 321′. The two ends 43″ are respectively near the two openings 21′ of the translucent tube shell 20′. Two opposite sides of the back surface 41″ respectively extend out of the abutting part 321′, thus, an extending space 411″ is respectively formed between the back surface 41″, the abutting part 321′ and each of the two slide bars 311′. The luminous surface 42″ has four electrical connecting parts 421″ and multiple LED units 422″. Each two electrical connecting parts 421″ are mounted near a corresponding one of the two ends 43″ on the luminous surface 42″ of the LED light board 40″. The multiple LED units 422″ are mounted at intervals on the luminous surface 42″ in a longitudinal direction of the LED light board 40″. In this embodiment, the LED light board 40″ is also convex toward the translucent tube shell 20′, wherein a radian of the LED light board 40″ corresponds to the radian of the top surface 32′. The multiple LED units 422″ are arranged in two lines in parallel and the two lines of the LED units 422″ are respectively mounted on two sides of the luminous surface 42″. The two lines of the multiple LED units 422″ are separated by a midline on the LED light board 40″ in a longitudinal direction of the LED light board 40″.

As the two lines of the multiple LED units 422″ are separated by the midline on the convex LED light board 40″, the two lines of the multiple LED units 422″ respectively face the translucent tube shell 20′ in two different directions. Therefore, an illumination angle of the third embodiment of the LED tube in accordance with the present invention is increased.

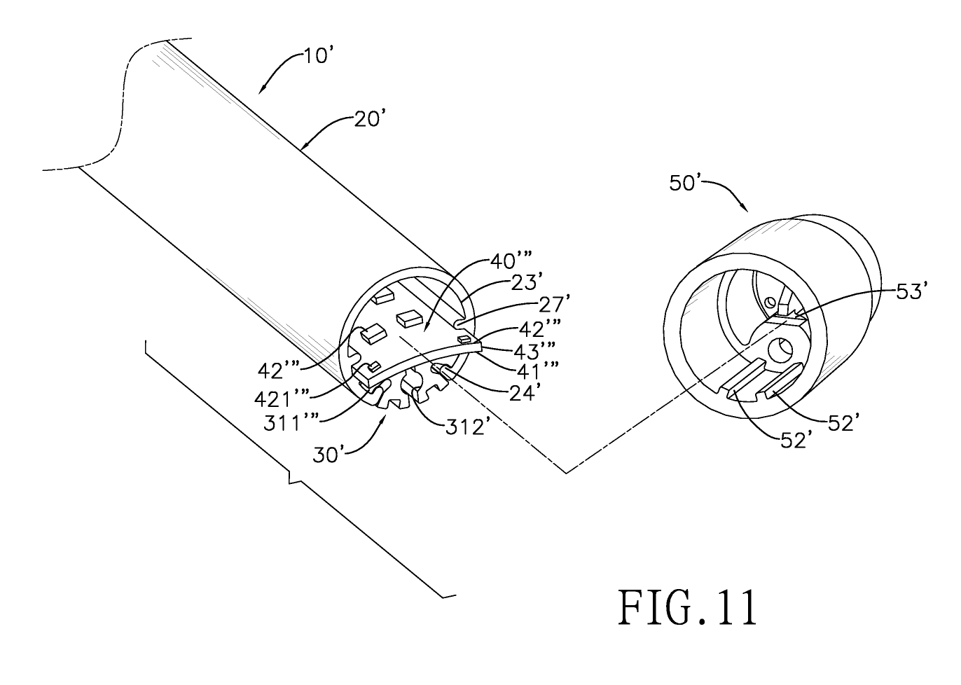

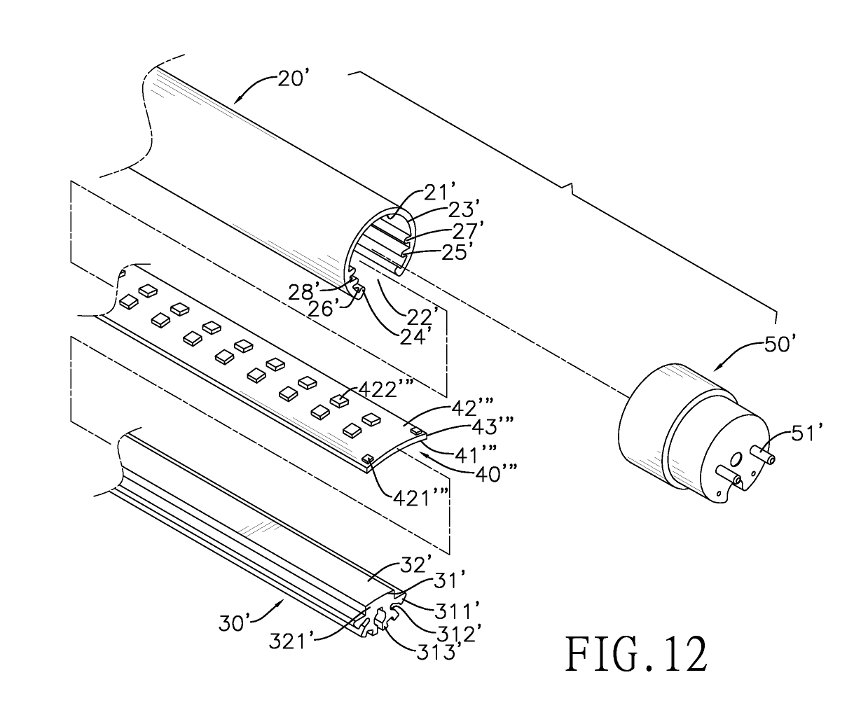

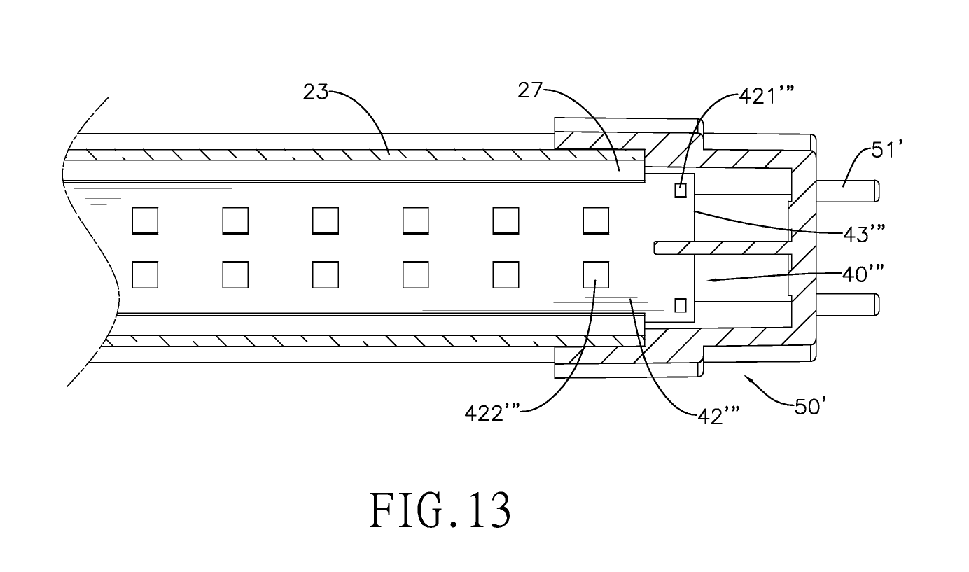

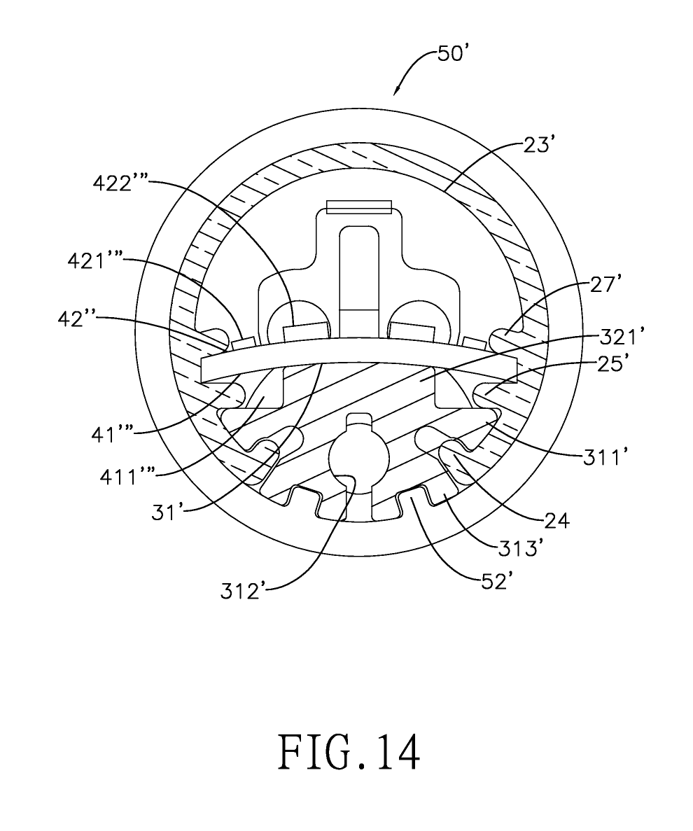

With reference to FIGS. 11 to 14, a fourth embodiment of an LED tube in accordance with the present invention comprises a tube body 10′, an LED light board 40′″ and two caps 50′, wherein a structure of the tube body 10′ of the fourth embodiment is similar to that of the third embodiment. Therefore, description of the structure of the tube body 10′ will not be repeated in the following paragraphs.

The LED light board 40′″ is mounted in the tube body 10′ and has two opposite sides respectively mounted in the two second slide tracks 28′, two opposite ends 43′″ connected to the two sides of the LED light board 40′″, a back surface 41′″ and a luminous surface 42′″ opposite to the back surface 41′″. The back surface 41′″ abuts the abutting part 321′ of the heat dissipating seat 30′. A length of the LED light board 40′″ in a width direction of the LED light board 40′″ is longer than a length of the abutting part 321′ in a width direction of the abutting part 321′. The two ends 43′″ are respectively near the two openings 21′ of the translucent tube shell 20′. Two opposite sides of the back surface 41′″ respectively extend out of the abutting part 321′, thus, an extending space 411′″ is respectively formed between the back surface 41″, the abutting part 321′ and each of the two slide bars 311′. The luminous surface 42′″ has four electrical connecting parts 421′″ and multiple LED units 422″. In this embodiment, a length of the LED light board 40′″ in a longitudinal direction of the LED light board 40′″ is longer than a length of the abutting part 321′ in a longitudinal direction of the abutting part 321′, wherein the LED light board 40′″ is also convex toward the translucent tube shell 20′, wherein a radian of the LED light board 40′″ corresponds in curvature to the radian of the top surface 32′. The two opposite ends 43′″ of the LED light board 40′″, which are respectively near the two opening 21′ of the translucent tube shell 20′, respectively extend out of the heat dissipating seat 30′, wherein each two electrical connecting parts 421′″ are mounted on the luminous surface 42′″ and near a corresponding one of the two ends 43′″ of the LED light board 40′″. The multiple LED units 422′″ are arranged in two lines in parallel and the two lines of the LED units 422′″ are respectively mounted on two sides of the luminous surface 42′″. The two lines of the multiple LED units 422′″ are separated by a midline on the LED light board 40′″ in a longitudinal direction of the LED light board 40′″.

The caps 50′ are respectively sleeved on the two openings 21 of the translucent tube shell 20. Each cap 50′ has an inner wall, two electrode pins 51′ and two fin fixing parts 52′. The two electrode pins 51′ are mounted through the cap 50′ and are electrically connected to two corresponding ones of the electrical connecting parts 421′″ respectively. The two fin fixing parts 52′ are formed on the inner wall of the cap 50′ and respectively correspond to the two fork parts 313′ of the two fins 312′. In this embodiment, each cap 50′ further has a board fixing groove 53′ and the board fixing groove 53′ is curved upwards to match the convex LED light board 40′″, wherein each end 43′″ of the LED light board 40′″ is mounted in a corresponding one of the two board fixing grooves 53′.

According to the previous paragraph, the fourth embodiment of the LED tube in accordance with the present invention has advantages of the first, the second and the third embodiments. The two opposite sides of the heat dissipating seat 30′ and the two opposite sides of the LED light board 40′″ are respectively mounted in the two first slide tracks 26′ and the two second slide tracks 28′ of the electrically insulating translucent tube shell 20′ to avoid a short-circuit between the heat dissipating seat 30′ and the LED light board 40′″. The two opposite ends 43′″ of the LED light board 40′″ extend out of the heat dissipating seat 30′ to further extend distances between the electrical connecting parts 421′″ mounted on the ends 43′″ and the heat dissipating seat 30′. The two lines of the multiple LED units 422′″ respectively face the translucent tube shell 20′ in two different directions to increase an illumination angle of the fourth embodiment of the LED tube in accordance with the present invention.

Above all, all the above-mentioned embodiments of the LED tube in accordance with the present invention have two first slide tracks 26, 26′ and two second slide tracks 28, 28′. Therefore, the LED light board 40, 40′, 40″, 40′″ is not mounted on the metal heat dissipating seat 30, 30′. Only the back surface 41, 41′, 41″, 41′″ of the LED light board 40, 40′, 40″, 40′″ abuts the abutting part 321, 321′ of the heat dissipating seat 30, 30′, and the luminous surface 42, 42′, 42″, 42′″ is distal from the heat dissipating seat 30, 30′. Therefore, internal creepage distances of all the above-mentioned embodiments of the LED tube in accordance with the present is extended to avoid a short-circuit between the heat dissipating seat 30, 30′ and the LED light board 40, 40′, 40″, 40′″ due to short creepage distances.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An LED tube having long internal creepage distances comprising:
a tube body having:
a translucent tube shell having
two openings;
a gap formed through the translucent tube shell in a longitudinal direction of the translucent tube shell;
two side walls separated by the gap;
two first slide tracks respectively formed on the two side walls; and
two second slide tracks respectively formed on the two side walls, wherein the two second slide tracks are respectively located above the two first slide tracks; and
a heat dissipating seat having two opposite sides slidably mounted in the two first slide tracks of the translucent tube shell respectively;
an LED light board having:
two opposite sides slidably mounted in the two second slide tracks of the translucent tube shell respectively;
two opposite ends connected to the two sides of the LED light board and respectively near the two openings of the translucent tube shell;
a back surface abutting the heat dissipating seat; and
a luminous surface opposite to the back surface and facing toward the translucent tube shell; and
two caps respectively mounted on and covering the two openings of the translucent tube shell, wherein each cap comprises
two electrode pins mounted through the cap and electrically connected to the LED light board.

2. The LED tube as claimed in claim 1, wherein the heat dissipating seat further comprises:
a top surface having
an abutting part extending from the top surface and abutting the back surface of the LED light board, wherein a length of the abutting part in a width direction of the abutting part is shorter than a length of the LED light board in a width direction of the LED light board; and
a bottom surface opposite to the top surface and having
multiple fins extending from the bottom surface and facing toward the gap of the translucent tube shell.

3. The LED tube as claimed in claim 2, wherein the luminous surface of the LED light board comprises:
four electrical connecting parts mounted on the luminous surface and each two of the four electrical connecting parts respectively disposed near a corresponding one of the two ends of the LED light board, wherein each electrical connecting part is electrically connected to two electrode pins of a corresponding one of the two caps.

4. The LED tube as claimed in claim 3, wherein
a length of the LED light board in a longitudinal direction of the LED light board is longer than a length of the abutting part in a longitudinal direction of the abutting part; and
the two ends of the LED light board extends out of the abutting part.

5. The LED tube as claimed in claim 4, wherein
the LED light board is convex toward the translucent tube shell; and
the abutting part of the heat dissipating seat is convex and corresponds in curvature to the LED light board.

6. The LED tube as claimed in claim 5, wherein the LED light board further comprises:
multiple LED units mounted on the luminous surface and arranged in two lines in parallel, wherein the two lines of the multiple LED units are separated by a midline on the LED light board in the longitudinal direction of the LED light board.

7. The LED tube as claimed in claim 2, wherein
each fin of the heat dissipating seat has a fork part formed on the fin; and
each cap has multiple fin fixing parts formed in the cap and respectively corresponding in position to the multiple fork parts of the heat dissipating seat.

8. The LED tube as claimed in claim 6, wherein
each fin of the heat dissipating seat has a fork part formed on the fin; and
each cap has multiple fin fixing parts formed in the cap and respectively corresponding in position to the multiple fork parts of the heat dissipating seat.

9. The LED tube as claimed in claim 4, wherein each cap further comprises:
a board fixing groove formed in the cap and corresponding in position to a corresponding one of the two ends of the LED light board.

10. The LED tube as claimed in claim 5, wherein each cap further comprises:
a board fixing groove formed in the cap, wherein the board fixing groove is curved upwards and corresponds in curvature to a corresponding one of the two ends of the LED light board.

11. The LED tube as claimed in claim 6, wherein each cap further comprises
a board fixing groove formed in the cap, wherein the board fixing groove is curved upwards and corresponds in curvature to a corresponding one of the two ends of the LED light board.

12. The LED tube as claimed in claim 1, wherein the LED light board further comprises:
multiple LED units mounted at intervals on the luminous surface in a longitudinal direction of the LED light board.

13. The LED tube as claimed in claim 2, wherein the LED light board further comprises:
multiple LED units mounted at intervals on the luminous surface in a longitudinal direction of the LED light board.

14. The LED tube as claimed in claim 3, wherein the LED light board further comprises:
multiple LED units mounted at intervals on the luminous surface in a longitudinal direction of the LED light board.

15. The LED tube as claimed in claim 4, wherein the LED light board further comprises:
multiple LED units mounted at intervals on the luminous surface in a longitudinal direction of the LED light board.

16. The LED tube as claimed in claim 2, wherein
the heat dissipating seat further comprises
two semi-annular grooves respectively formed on two adjacent fins of the multiple fins, wherein the two semi-annular grooves face each other; and
each cap further comprises a screw having
a screw rod mounted through the cap and between the two semi-annular grooves of the heat dissipating seat; and
a screw head connected to the screw rod and abutting the cap.

17. The LED tube as claimed in claim 3, wherein
the heat dissipating seat further comprises
two semi-annular grooves respectively formed on two adjacent fins of the multiple fins, wherein the two semi-annular grooves face each other; and
each cap further comprises a screw having
a screw rod mounted through the cap and between the two semi-annular grooves of the heat dissipating seat; and
a screw head connected to the screw rod and abutting the cap.

18. The LED tube as claimed in claim 4, wherein
the heat dissipating seat further comprises
two semi-annular grooves respectively formed on two adjacent fins of the multiple fins, wherein the two semi-annular grooves face each other; and
each cap further comprises a screw having
a screw rod mounted through the cap and between the two semi-annular grooves of the heat dissipating seat; and
a screw head connected to the screw rod and abutting the cap.

19. The LED tube as claimed in claim 11, wherein
the heat dissipating seat further comprises
two semi-annular grooves respectively formed on two adjacent fins of the multiple fins, wherein the two semi-annular grooves face each other; and
each cap further comprises a screw having
a screw rod mounted through the cap and between the two semi-annular grooves of the heat dissipating seat; and
a screw head connected to the screw rod and abutting the cap.
